(19) United States
(12) Patent Application Publication
(10) Pub. No.: US 2012/0046407 A1
(43) Pub. Date: Feb. 23, 2012

(54) METHOD OF PREPARING STIMULUS-RESPONSIVE POLYMERIC PARTICLES

(76) Inventors: Andrew Clarke, Cambridge (GB); Stephanie Vronique Desrousseaux, Arbonne (FR); Danuta Gibson, Cambridgeshire (GB); John Martin Higgins, Middlesex (GB); Andrew Michael Howe, Cambridgeshire (GB); Trevor John Wear, Cambridgeshire (GB)

(21) Appl. No.: 13/141,702

(22) PCT Filed: Dec. 17, 2009
(86) PCT No.: PCT/US2009/006598

§ 371 Date: Nov. 9, 2011

(30) Foreign Application Priority Data
Dec. 23, 2008 (GB) 0823400.7

(51) Int. Cl. C09D 11/10; C08L 21/02; B01J 13/02; H01B 1/20; H01F 1/00; C08F 257/02; C08F 265/10; C08L 51/06

(52) U.S. Cl. 524/458; 525/296; 525/267; 524/534; 427/213.3

(57) ABSTRACT

A method of making a polymeric compound, comprising discrete particles responsive to an external stimulus, that is resistant to aggregation in high-shear fields, which includes the addition of a polymerization initiator to a reaction mixture comprising a monomer corresponding to the polymeric compound, wherein the method comprises the portion-wise addition of aliquots of a cross-linking agent to the reaction mixture, wherein an aliquot of the cross-linking agent is added to the reaction mixture both before the addition of the polymerization initiator and after the polymerization has progressed substantially to completion. The polymer particles are largely immune to the effects of transient shear rates at least as high as 10⁶ s⁻¹, whilst maintaining their thermal responsiveness and being present at moderate concentration. The structural and chemical modifications brought by the delayed portion-wise addition of the cross-linking agent allow an improvement in stability in a high-shear field.

### FIELD OF THE INVENTION

The present invention relates to a method of preparing a polymeric compound comprising discrete particles that are responsive to an external stimulus, especially thermal stimulus, and are resistant to aggregation in high-shear fields, to the polymeric compound obtainable by the process and its use in an aqueous composition, for example, in inkjet printing systems for reducing or preventing such aggregation. The method comprises the portion-wise addition of aliquots of a cross-linking agent typically both before and after the addition of the polymerization initiator to reduce or prevent the aggregation.

### BACKGROUND OF THE INVENTION

Cross-linked, water-swellable, stimulus-responsive particles, such as ‘microgels’, have been the subject of extensive studies that take advantage of the switchable properties of such materials. The unique feature of these hydrophilic ‘microgels’ is that swelling with water and all related properties are very sensitive to an external stimulus, such as temperature. For example, the particle volume can typically decrease by a factor of ten when the temperature is changed from typical room temperature to 40° C. and the particle nature changes from being highly hydrophilic to highly hydrophobic. This latter property switch is particularly pertinent because the stability of aqueous, hydrophobic particle dispersions is much worse than that of aqueous hydrophilic dispersions.

The synthesis used to make such materials is a typical emulsion polymerization reaction, wherein the required monomer is reacted with a cross-linking agent, and optionally a surfactant, in an aqueous solution from which oxygen has been purged, with stirring. After heating, polymerization is initiated by addition of a polymerization initiator. The formed polymer is insoluble in the reaction medium and forms particles. The mixture is stirred, in the absence of oxygen to the required temperature for a number of hours, typically 5 hours, until the polymerization is complete, after which the heating is switched off and the mixture left to cool down to room temperature. The reaction yields a dispersion which is then purified by, for example, dialysis.

The role of the cross-linking agent in the initial reaction mixture is to ensure that the swollen polymer behaves as a soft particle when the temperature of the particle suspension is reduced. Typical of emulsion polymerizations, the cross-linking agent starts to be consumed right from the start of the reaction when the polymer particles have high polymer concentrations. The result of this reaction procedure is a ‘microgel’ with domains of cross-linking within the particles (see for example, Pelton et al., Colloid Polym. Sci, 272, 467-477 (1994)).

In the same way, the kinetics of the reactions made in this way are also well-documented (ibid). Pelton et al. show that under the reaction conditions typically used in this invention, and in particular for the preparation of poly (N-isopropylacrylamide, the monomer conversion, that is the progress towards completing the polymerization reaction, is approximately 50% complete after 5 minutes after the polymerization initiation, 90% complete after 15 minutes and more than 95% after 30 minutes (see FIG. 1).

Polymeric compounds can be made in several forms. For example, hydrogels are water-swollen networks (cross-linked structures) of hydrophilic homopolymers or copolymers. They are three-dimensional and the cross-links can be formed by covalent or ionic bonds (‘Preparation methods and structure of Hydrogels’, N. A. Peppas, A. G. Mikos, Hydrogels in medicine and pharmacy, Volume I Fundamentals, Ed. N. A. Peppas, Chapter 1, 1-25 (1985).

Microgels as described by Baker (W. O. Baker, ‘Microgel, a new macromolecule’, Ind Eng Chem 41 (1949) 511-520) were defined as a new architecture for polymer particles that comprises cross-linked hydrophobic latex particles which swell in organic solvents to form colloidally dispersed gel particles. Over the last 20 years, interest has grown in hydrophilic microgels, i.e. cross-linked hydrophilic polymers, which swell in water. These microgels, as prepared in accordance with this invention, are intermediate between branched and macroscopically-cross-linked polymers and can best be described as (typically) having a narrow size distribution, and being spherical particles with average diameters from 50 nm to 5 μm (Current Opinions in Colloid and Interface Science, 13 (2008) 413-428).

The IUPAC definition of ‘latex’ is an emulsion or sol in which each colloidal particle contains a number of macromolecules (Chapter 1, Les latex synthétiques, Lavoisier 2006). Practically, academic and industry scientists working in the field consider a synthetic latex to be a colloidal dispersion of particles composed of macromolecules, usually an aqueous dispersion. Thus, the term ‘synthetic latex’ is a very broad term which can also encompass ‘microgels’. However, hydrophilic microgels are very specific latexes: they are cross-linked polymers and they have the capability to swell in water whereas not all latexes can do this. For example polystyrene, a common synthetic latex, does not swell in water, whether or not a cross-linking agent is present.

In a series of patents and patent applications identified below, Gannaphthiappan discloses a means of making polymer latex particles that are principally hydrophobic and that have improved ‘thermal shear stability’, wherein ‘thermal shear stability’ means that the particle size does not change over time, as demonstrated by stirring the particles in a high-speed blender for a few minutes. The ‘thermal stability’ refers particularly to the use of the particles in thermal inkjet printers wherein the ink is subjected to a thermal shock when ejecting inkjet droplets.

In particular U.S. Pat. No. 6,858,301 reveals specific core-shell polymer latex particles comprising a polymerized hydrophobic core, which is optionally cross-linked, and a shell comprising a copolymer mixture of at least one hydrophobic co-monomer, at least one hydrophilic co-monomer and a second cross-linking agent. US Patent Publication No. 2006/0199877 discloses latex particles comprising at least one hydrophobic monomer cross-linked with an acid-bearing monomer. US Patent Publication No. 2003/0060562 claims amphipathic latex particles with a pH-responsive moiety, wherein the particle is hydrophobic in an acid environment and hydrophilic in a basic environment. U.S. Pat. No. 6,960,617 discusses hydrogels composed of two or more different, inter-penetrating polymer networks with improved elasticity and mechanical strength properties, wherein the selection of polymer networks is preferably restricted to thermally-stable polymers. US Patent Publication No. 2008/0182960 refers to surface cross-linked latex particles that are cross-linked using functional groups at the surface of the particles with no substantial cross-linking occurring below this surface. In all these cases the particles are latexes or hydrogels, rather than microgels, the particle character being hydrophobic only in the latexes and the material being a network and not a colloidal particle in the hydrogels. Moreover none of the particles is thermally-responsive and so particle stability is independent of the state of the particle as defined by the particle temperature.

In U.S. Pat. No. 5,306,593 Cunningham and Mahabadi describe a process for preparing polymer particles by starved-feed monomer addition, wherein the monomers, and optionally the cross-linking agents, are progressively added after the polymerization reaction has been initiated, to provide particles with high molecular weight and cross-linked domains. However the portion-wise addition of aliquots of cross-linking agents before and after the polymerization initiation to provide a uniformly cross-linked polymeric material is not taught.

In U.S. Pat. No. 4,493,777 Snyder and Peters disclose aqueous fluids containing cross-linked microgel particles possessing superior lubricating and wear-resistant characteristics. Again the particles are not stimulus-responsive and in addition cross-linking is used only to control the degree of swellability in order to prevent particle wear. In U.S. Pat. No. 6,100,222 Vollmer et al. describe cross-linked, hydrophobic latex particles as being more stable under severe thermal shear conditions when printed through a thermal inkjet print head. However, the cross-linking agent is introduced in the usual manner, that is, only at the start of the reaction. No shear stability is shown but cross-linking is proved by examining the solubility of the latex in organic solvents.

WO 2008/075049 describes an aqueous inkjet ink composition comprising a colorant and a polymeric compound comprising discrete particles responsive to an external stimulus, the particles having a lower viscosity in a first rheological state and a higher viscosity in a second rheological state. The use of a cross-linking agent to maintain the shape of the polymer particle is disclosed but there is no teaching that a cross-linking agent may be added after the polymerization initiation to reduce or prevent aggregation in a high-shear field.

In Journal of Polymer Science: Part A Polymer Chemistry, 31, 963-969 (1993), Tam et al. describe the use of an anionic surfactant to increase the stability versus aggregation of a thermally-responsive linear polymer, poly (N-isopropylacrylamide), when the temperature is above its lower critical solution temperature. However, this stability is assessed only under very low shear rate.

### PROBLEM TO BE SOLVED BY THE INVENTION

Liquid-based formulations containing particles are used in many processes, for example as inks. In some applications, the formulations contain water-swellable, cross-linked polymers or ‘microgels’. In such applications formulations may be required to be pumped to pass through a filter or to pass along small channels in order, for example, to remove oversized particles by filtration or to generate and manipulate small volumes of liquid, for example for microfluidic applications, such as inkjet printing. The formulations are then subjected to a flow field that is characterized by high rates of shear and/or extension.

It is important for the success of the formulations in these applications that the microgel particles and other components are not aggregated as a consequence of experiencing the flow fields within the pump, the filter or the narrow channels. Low levels of aggregation would have affects on the rheology or product properties that are detrimental in that, for example, there could be phase separation; high levels of aggregation would serve to block the pump, filters or channels and so completely arrest the process.

### SUMMARY OF THE INVENTION

According to the invention there is provided a method of making a polymeric compound, comprising discrete particles responsive to an external stimulus, that is resistant to aggregation in high-shear fields, which includes the addition of a polymerization initiator to a reaction mixture comprising a monomer corresponding to the polymeric compound, wherein the method comprises the portion-wise addition of aliquots of a cross-linking agent to the reaction mixture, wherein an aliquot is added after the polymerization has progressed substantially to completion.

In another aspect there is a provided a polymeric compound obtainable by a method as hereinbefore defined. In a further aspect there is provided the use of the polymeric compound in an aqueous composition in an inkjet printing system to reduce or prevent aggregation in a high shear field. In yet another aspect there is provide a method of reducing or preventing aggregation in a high shear field comprising the use of a polymeric compound or a composition thereof as prepared by the method.

### ADVANTAGEOUS EFFECT OF THE INVENTION

There are many processes in which liquid-based formulations containing particles are exposed to high-shear fields. However, it is usually vital to the working of those processes that particles do not aggregate in an uncontrolled fashion. The specific particles provided by this invention are largely immune to the effects of transient shear rates at least as high as 10⁶ s⁻¹, whilst maintaining their thermal responsiveness and being present at moderate concentration. In addition, the structural and chemical modifications brought by the delayed portion-wise addition of aliquots of the cross-linking agent allow an improvement in stability in a high-shear field, even in the absence of a formulation additive such as a surfactant.

### BRIEF DESCRIPTION OF THE DRAWINGS

FIG. 1 represents the total monomer conversion mol % of N-isopropylacrylamide to poly(N-isopropylacrylamide) as a function of the reaction time in minutes.

FIG. 2 is a graph of hydrodynamic particle diameter in nm v. temperature of a stimulus-responsive particle (Curve A) and a latex polymer (Curve B).

FIG. 3 represents a diagram of the microfluidics device used to assess high-shear field stability of microgel dispersions, wherein A is the Sample Input, B is the pre-filter region, C is the Sample Measurement region, D is the Sample Output and E is an enlargement of C, wherein the arrows indicate the five, 10 μm gaps.

FIG. 4 represents the microfluidics device free of aggregation under testing conditions.

FIG. 5 represents the microfluidics device blocked with aggregated microgel suspension under testing conditions.

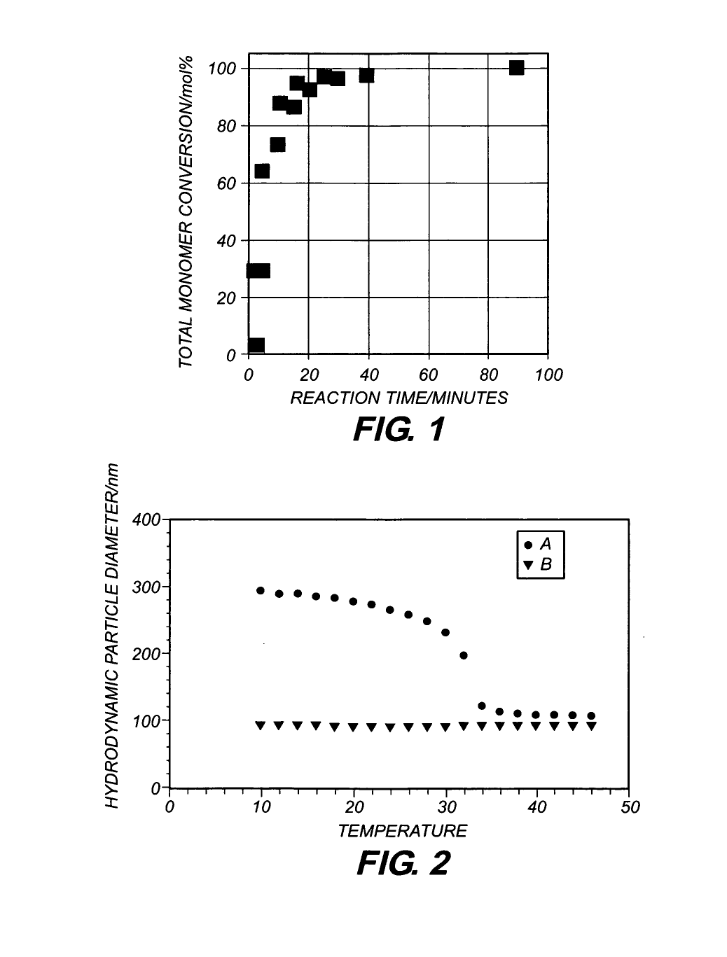

### DETAILED DESCRIPTION OF THE INVENTION

Aggregation is a phenomenon seen in many suspensions of relevance to industrial processes. Because this phenomenon can be extreme in nature, for example, the complete cessation of what may have been a free fluid-flow, it is generally desirable to avoid such behaviour. The rheological manifestation is an abrupt rise in suspension viscosity as shear rate is increased, but this is so abrupt that it can be difficult to study using controlled shear-rate rheometers. As used herein and throughout the specification, high and low shear rates are defined as greater than and less than 10⁵ s⁻¹ respectively.

Moreover it can be difficult to reproduce the very high shear rate conditions generated in many practical applications and it is difficult to visualise exactly what is happening in a rheometer. In rotational rheometers it is difficult to obtain shear rates greater than 10⁵ s⁻¹. A microfluidic apparatus has a flow field similar to that in inkjet printers or that of a microfluidics disperser, the fluid moving relative to stationary walls rather than one wall moving and the other being at rest.

For these reasons, a microfluidic device made in polydimethyl-siloxane (PDMS) is used herein to create a fluid flow device to test for aggregation, as shown in FIG. 3, the device advantageously using only small quantities of material. The device has an input flow region A through a low-shear filter B, with an optional by-pass flow to enable flushing of the filter. A high-shear region C leads to the output flow D. The channels in the microfluidic device are 40 μm in depth and 200 μm in width, whereas the high-shear region C consists of a narrowing of the channel width to pass the fluid between a series of pillars defining one or more, and typically five, 10 μm gaps as shown in E. This arrangement provides a flow field in the high-shear region approximating to that found in the 12 μm nozzle of a continuous inkjet head, when pumped using a syringe pump at low flow rates.

All the examples were tested in the microfluidics device under the same range of high-shear field and as a consequence, their stabilities versus aggregation could be compared. Thus in accordance with the invention, suspensions of thermally-responsive polymeric particles, made by emulsion polymerization, could be exposed to varying shear conditions, producing shear rates, for example, from 5×10⁵s⁻¹ to 10.6×10⁶s⁻¹ via adjustment of the flow rate, using the microfluidics device described above.

The shear rate may be estimated as

(2Q)/(w·h·n·δ),

wherein Q is the device flow rate, w the width of the channel, h the height of the channel, n the number of channels and δ the boundary layer thickness within the channel.

Thus screening could be made of suspensions resulting from variations in the synthesis of the polymeric particles and in particular variation in the amount and method of introducing the cross-linking agent to the reaction mixture, as well to the point at which that addition was made. Thus in evaluating the addition of a part of the cross-linking agent after the reaction had been initiated, experimental variations included adding the agent dropwise over a period or portion-wise as ‘one-shot’, that is, as one ‘aliquot’. The time when the cross-linking agent was added was also varied, with particular focus on delaying the addition after polymerization initiation.

As used herein and throughout the specification the term, ‘aliquot’ with respect to cross-linking agent is defined in accord with its normal chemical meaning as a fraction of a whole quantity of the cross-linking agent, added as a single portion. As such it specifically excludes dropwise addition thereof. In response to an external stimulus, such as temperature, the suspension of particles of the polymeric ‘microgels’ change from a first rheological state to a second rheological state. This change in rheological states of the suspension of stimulus-responsive particles equates to differences in size or shape or more particularly volume, represented by equivalent spherical diameter of the particles, the term equivalent spherical diameter being used in its art recognized sense in recognition of particles that are not necessarily spherical. Thus when in a collapsed state the stimulus-responsive particles have an equivalent spherical diameter considerably less than the diameter of the orifice or restriction they need to pass through, typically less then 2 μm, preferably 0.5 μm or less, more preferably 0.15 μm or less and especially 0.01 to 0.15 μm, for applications employing microfluidic or filtering processes. Lowering the temperature causes an expansion of the stimulus-responsive particles as shown in curve A in FIG. 2 as compared to no volume change when a non stimulus-responsive latex polymer is used (Curve B in FIG. 2). In other applications, the size and shape of the stimulus-responsive polymer particle needs to be appropriate to the purpose for which it is required.

In the embodiments wherein the stimulus-responsive particles are thermally-responsive, the temperatures at which switching occurs is referred to hereinafter as the ‘switching temperature’. The ‘switching temperature’ can be fine-tuned to adapt to exterior conditions by appropriate selection of the stimulus-responsive polymer particles. This can be done either by inclusion/exclusion of a co-monomer with appropriate hydrophilic or hydrophobic character in the main stimulus-responsive polymer fragment or by inclusion or adjustment of concentration of other components in the composition, such as a surfactant. However it is desirable that most of the volume change from a lower to a higher volume induced by the temperature change, and most of any change in properties, for example viscosity, occurs over as small a temperature range as possible.

However the invention is also applicable to polymer particles which are responsive to other than temperature change such as, for example, changes in pH or light or an electrical or magnetic change or a combination thereof. The skilled person would readily appreciate alternative forms of enabling a significant change in response to a number of external stimuli to achieve the benefit of the present invention. In all cases it is desirable that the switching point from one rheological state to another occurs over as small as a range as possible.

The stimulus-responsive particles, especially thermally-sensitive polymers, may be prepared, for example, by polymerization of monomers which will impart thermal sensitivity, such as N-alkylacrylamides, such as N-ethyl-acrylamide and N-isopropylacrylamide, hereinafter NIPAM, N-alkyl-methacrylamides, such as N-ethylmethacrylamide and N-isopropyl-methacrylamide, vinylcaprolactam, vinyl methylethers, partially-substituted vinylalcohols, ethylene oxide-modified benzamide, N-acryloylpyrrolidone, N-acryloylpiperidine, N-vinylisobutyramide, hydroxyalkylacrylates, such as hydroxyethyl acrylate, hydroxyalkylmethacrylates, such as hydroxyethyl-methacrylate, and copolymers thereof, by methods known in the art.

For instance, Varghese et al. (Journal Chemical Physics, 112, 6, 3063-3070, 2000) describe a thermally-sensitive co-polymer composed of a critical molar ratio of a highly hydrophilic co-monomer (2-acrylamido-2-methyl propane sulfonic acid) and a highly hydrophobic co-monomer (N-tertiary butylacrylamide), although neither of the homopolymers is thermally-sensitive.

Another class of thermally-sensitive polymers is composed of copolymers of 2-(2-methoxyethoxy)ethyl methacrylate and oligo(ethylene glycol) methacrylate, as described by Lutz et al. in Journal of the American Chemical Society, 2006, 13046-13047.

The thermally-sensitive polymer particles can also be prepared by micellization of stimulus-responsive polymers and cross-linked while in micelles. This method applies to such polymers as, for example, certain hydroxyalkyl-celluloses, aspartic acid, carrageenan and copolymers thereof.

Alternatively block copolymers of the stimulus-responsive particles may be created by incorporating one or more other unsubstituted or substituted polymer fragments such as, for example, polyacrylic acid, polylactic acid, polyalkylene oxides, such as polyethylene oxide and polypropylene oxide, polyacrylamides, polyacrylates, polyethyleneglycol methacrylate, polyvinyl alcohol, polyvinyl acetate, polyvinylpyrrolidone, polyvinyl chloride, polystyrene, polyalkyleneimines, such as polyethyleneimine, polyurethane, polyester, polyurea, polycarbonate or polyolefins. Introduction of a copolymer, such as a polyacrylic acid or polyethyleneglycol methacrylate, may be useful to fine-tune the switching temperature and swellablity.

Alternatively copolymers of stimulus-responsive particles may be created by incorporating one or more other unsubstituted or substituted co-monomers when the particle is synthesised. For example, acrylate or methacrylate derivatives, such as acrylic acid or polyethylene glycol methacrylate, acrylamide, substituted acrylamide, such as dimethylacrylamide or acrylamidomethyl propane sulfonic acid and salt derivatives thereof, and vinylic derivatives such as vinyl alcohol, vinyl benzene, vinyl amine, vinylacetic acid or 1-vinyl-2-pyrrolidinone, or other monomers with an unsaturated bond which can undergo addition polymerisation, such as fumaric acid, maleic acid and anhydride thereof, may be used. Other alkyl homologues of NIPAM can give higher or lower switching temperatures. Switching temperature is also known as LCST, that is lower critical solution temperature.

Any polymeric acidic groups present may be partially or wholly neutralized by an appropriate base, such as, for example, sodium or potassium hydroxide, ammonia solution, alkanolamines, such as methanolamine, dimethylethanolamine, triethylethanolamine or N-methylpropanolamine or alkylamines, such as triethylamine. Conversely, any amino groups present may be partially or wholly neutralized by appropriate acids, such as, for example, hydrochloric acid, nitric acid, sulfuric acid, acetic acid, propionic acid or citric acid. The copolymers may be random copolymers, block copolymers, comb copolymers, branched, star or dendritic copolymers.

Particularly preferred stimulus-responsive polymers for use in the preparation of the stimulus-responsive particles of the present invention are, for example, a poly-N-alkylacrylamide, especially poly-N-isopropylacrylamide, hereinafter PNIPAM), and a poly-N-alkylalkylacrylamide-co-acrylic acid, especially poly-N-isopropylacrylamide-co-acrylic acid, poly-N-isopropyl-acrylamide-co-polyethyleneglycol methacrylate, polyhydroxypropylcellulose, polyvinyl caprolactam, polyvinylalkylethers, such as polyvinylmethylether, or ethyleneoxide-propylene oxide block copolymers.

The number of monomers units in the stimulus-responsive polymer particles may typically vary from 20 to 1500 k. For example the number of monomer units in poly(NIPAM) is from 200-500 k and for poly-vinylcaprolactam is from 20 to 1500 k.

In accordance with the invention a cross-linking agent is used to maintain the shape of the polymer particle and to reduce or prevent aggregation in a high-shear field. Too high a concentration of cross-linking agent, however, may inhibit the swellability in response to the stimulus. Usually, the quantity of cross-linking will determine the cross-linking density of the polymer particles and may adjust, for example, the swelling degree and/or phase transition temperature of the nonionic polymer. In general, the total quantity of cross-linking agent used with respect to the major type of the monomer should be in the range of 0.05-7 mol %, preferably 1.3-5.5 mol %, more preferably 2.0-4.5 mol %, although not specifically limited thereto. In accordance with the invention aliquots are added to the reaction mixture, one aliquot being added preferably before the addition of the polymerization initiation or as soon as is practicable thereafter and a further aliquot being added when the polymerization reaction is substantially complete. As used herein and throughout the specification, the polymerization reaction is substantially complete when the reaction has progressed at least to 75% completion, more preferably at least to 85% completion, and most preferably to 90% completion.

Suitable cross-linking agents for this purpose include, for example, any materials which will link functional groups between polymer chains and the skilled artisan would choose a cross-linking agent suitable for the materials being used, for example, via addition or condensation chemistry. Examples of suitable cross-linking agents include N,N′-methylenebisacrylamide, hereinafter BIS, N,N′-ethylenebisacrylamide, dihydroxyethylenebisacrylamide, N,N′bisacroyloyl-piperazine, ethylene glycol dimethacrylate, polyethylene glycol dimethacrylate, a trifunctional cross-linking agent, such as triacrylate derivatives, for example, glycerin triacrylate, divinylbenzene, vinylsulfone or carbodiimides. The cross-linking agent may also be an oligomer with functional groups which can undergo condensation with appropriate functional groups on the polymer. The cross-linking agent is used for partial cross-linking the polymer. The particles can also be cross-linked, for example, by heating or ionizing radiation, depending on the functional groups in the polymer, in addition to the use of the cross-linking agent.

The polymer particle may also be in the form of a core/shell particle wherein the polymer forms a shell that surrounds a core. The interaction with the core can be of a chemical nature such that the polymer would be grafted onto the surface of the core by bonds which are preferably covalent. However the interaction can be of a physical nature, for example the core can be encapsulated inside the switchable polymer shell, the stability of the core/shell assemblage being obtained by the cross-linking of the shell material. The core could be functionalized or non-functionalized polystyrene, latex, silica, titania, a hollow sphere, magnetic or conductive particles or could comprise an organic pigment.

In the case of a core/shell particle, typically the equivalent spherical diameter of the core would be in the range of 0.005-0.15 μm and the switchable shell grafted on to the surface of the core would be sufficient in the contracted state to provide a core/shell particle with such a diameter considerably less than the diameter of the orifice to prevent blockage and enable passage through an orifice or restriction as above. Thus the core/shell particle would have a particle equivalent diameter as stated above for a non-core/shell particle.

The polymerization may be initiated using a charged or chargeable initiator species, such as, for example, a salt of the persulfate anion, especially potassium persulfate, or with a neutral initiator species if a charged or chargeable co-monomer species is incorporated in the preparation. The initiation of the radical polymerization may then triggered by the decomposition of the initiatior resulting from exposure to heat or to light. In the case of initiation using heat, a reduced temperature can be used by combining the initiator compound, such as potassium persulfate, with an accelerator compound, such as sodium metabisulfite.

Surfactants or mixtures of surfactants may be used for the synthesis of the stimulus-responsive microgel particles to control the size of the particles. The surfactants may be anionic: for example, sodium dodecylsulfate, hereinafter SDS, salts of fatty acids, such as salts of dialkylsulfosuccinic acid, especially sodium dioctyl sulfosuccinate, hereinafter AOT, salts of alkyl and aryl sulfonates and salts of tri-chain amphiphilic compounds, such as sodium trialkyl sulfo-tricarballylates. The anionic surfactants may also comprise hydrophilic non-ionic functionalities, such as ethylene oxide or hydroxyl groups. They may be nonionic: for example, polyoxyethylene alkyl ethers, acetylene diols and their derivatives, copolymers of polyoxyethylene and polyoxypropylene, alcohol alkoxylates, sugar-based derivatives; they may be cationic, such as alkyl amines, quaternary ammonium salts; or they may be amphoteric: for example, betaines. However the surfactant should normally be selected such that it is either uncharged (non-ionic), has no overall charge (amphoteric or zwitterionic surfactant) or matches the charge of the stimulus-responsive polymer used. The preferred surfactants include acetylene diol derivatives, such as Surfynol® 465 (available from Air Products Corp.) or alcohol ethoxylates such as Tergitol® 15-S-5 (available from Dow Chemical company), but the most preferred are SDS and AOT. The surfactants can be incorporated in the initial reaction mixture with a molar ratio up to 3 mol % of the total monomer amount, preferably 0.5 to 2.5 mol %, more preferably 0.7 to 1.5 mol %.

Surfactants selected from those above, or mixtures of surfactants, may also be used as an additive in a composition containing stimulus-responsive microgel particles to improve stability versus aggregation. For this purpose the surfactant can be incorporated in the composition with a concentration of up to 10 mmol/l, preferably 2 to 8 mmol/l.

The stimulus-responsive microgel particles can be used as components in many applications, for example, in inks, particularly in inkjet inks, for example, for ‘drop-on-demand’ or ‘continuous’ inkjet printing, in conventional printing inks, for example, for lithography, flexography, gravure or screen printing, in ‘inks’ or ‘toners’ for electrophotography, in fluids for microfluidic devices, in cosmetics, in medical applications, for example, for drug delivery, in photonic applications, or in any of the applications that capitalise on the responsive nature of the material and the property changes this brings.

The invention will now be described with reference to the following examples, which are however, in no way to be considered limiting thereof.

### EXAMPLES

The following examples illustrate methods of preparing polymeric particles wherein the addition of cross-linking agent is varied in amount and at the point of addition as summarized in the following Tables. In each example the monomer, surfactant and cross-linking agent, when initially present, were added to a double-walled glass reactor equipped with a mechanical stirrer and condenser, the mixture was heated before addition of the polymerization initiator, with any further addition of cross-linking agent where indicated. The N-isopropyl-acrylamide monomer, hereinafter NIPAM, the surfactant bis(2-ethylhexyl)-sulfosuccinate sodium salt (sodium dioctyl sulfosuccinate), hereinafter AOT, and the cross-linking agent methylenebisacrylamide, hereinafter BIS, were all obtainable from Sigma-Aldrich™ and the surfactant sodium dodecyl sulfate, hereinafter SDS, was obtainable from Fluka. In the following examples, the wt % of cross-linking agent is the weight ratio of the cross-linking agent to NIPAM monomer.

The particle size of the suspension of the thermally-sensitive particles was in each case measured by photon correlation spectroscopy, PCS, and determined with a Malvern ZetasizerNano ZS. A dilute sample of thermally-sensitive particles was obtained from the purified sample and was diluted with milli-Q water, a typical sample concentration being 0.05 wt %. Samples were equilibrated at each temperature for 10 min. and then the size was measured 5 times, such that the total time at each temperature was approximately 25 min. The results quoted are the mean of the measurements. The volumetric swelling ratio is the cubic ratio between the hydrodynamic diameter measured at 20° C. and the hydrodynamic diameter measured at 50° C.

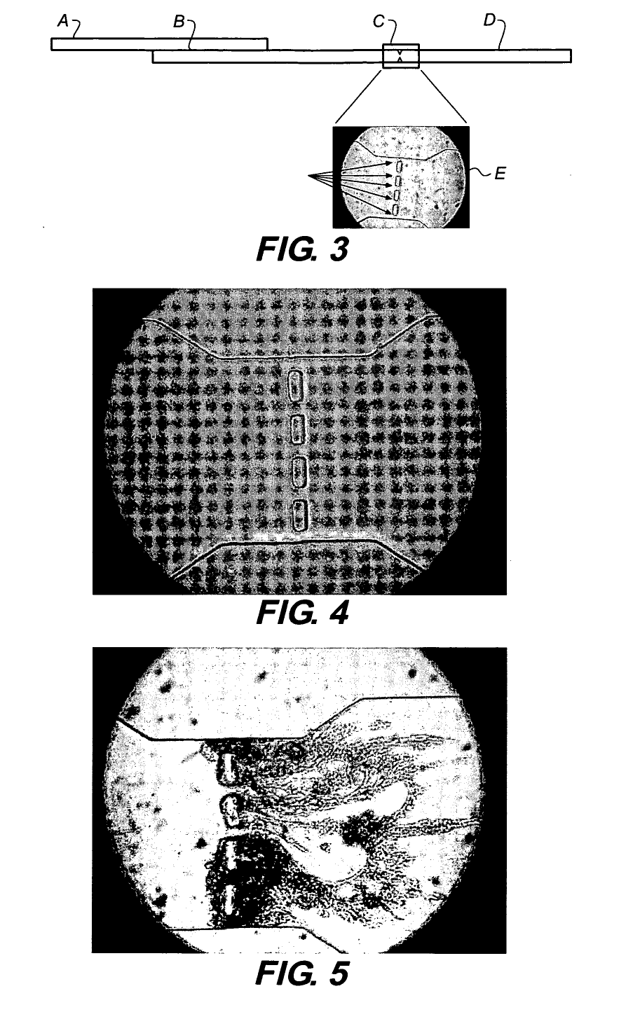

The stability versus aggregation under high-shear field was assessed by running a 4 wt % polymer dispersion with 4 mmol/l SDS, unless otherwise specified, in a microfluidics channel in a device as hereinbefore described and as shown in FIG. 3, with the high-shear region consisting of a narrowing of the channel width to pass the fluid between a series of pillars defining five 10 μm gaps. The typical flow rate was 6 cm³/h (˜8×10⁵s⁻¹). The sample was said not to aggregate when the channel remained free under a steady state (FIG. 4). The sample was said to aggregate when the channel was blocked when a steady state was reached (FIG. 5). The tests were performed at 50° C. in order to get sufficient fluidity for the dispersion.

When microgels particles were particularly stable under the above conditions and in the presence of 4 mmol/l SDS, the stabilizing surfactant was removed from the 4 wt % formulation polymeric dispersion and the extent of aggregation was compared for lower flow rates, typically 2 and 4 cm³/h.

### Comparative Example 1

### Poly(butylacrylate-co-methyl methacrylate) latex dispersion (C1)

Revacryl™ 803 (Synthomer™ Ltd) is a butyl acrylate-co-methyl-methacrylate latex solution made of colloidal particles of a non water-swellable uncross-linked polymer. The particle size is 100 nm, as provided by the supplier. Test of a 4 wt % solution of latex in water did not show any aggregation in the microfluidics device, as shown in TABLE 1.

### Comparative Example 2

### Poly (N-isopropylacrylamide) (PNIPAM) Microgel; Sodium Dodecyl Sulfate (SDS) surfactant; 2 wt % N,N-methylenebisacrylamide (BIS) (BIS/NIPAM Ratio) Added Only Before Addition of the Polymerization Initiator, Potassium Persulfate (C2)

This PNIPAM microgel was a water swellable cross-linked polymer prepared according to the method described in WO2008/075049A1, using SDS as a surfactant. 15.8 g N-isopropylacrylamide (NIPAM), 0.303 g BIS and 0.305 g SDS were added to a 1 L reactor. 900 ml water was added, the mixture warmed to 40° C. and purged with nitrogen for 30 min., while being stirred at 500 rpm. The solution was then heated to 70° C. and 0.602 g potassium persulfate initiator (dissolved in 20 ml deionized water which had been purged with nitrogen) was added quickly to the reactor. The mixture was stirred at 400 rpm at 70° C. for 6 h under nitrogen. The reaction mixture rapidly became opalescent, then white. The heating was switched off and the mixture left to cool to room temperature. The reaction yielded a white dispersion which was filtered, then dialyzed until the conductivity of the permeate was less than 10 μS/cm.

Cross-linking agent/monomer molar ratio 0.014.
Particle hydrodynamic diameter 288 nm at 20° C.; 124 nm at 50° C.
Volumetric swelling ratio 12.5.

Test of a 4 wt % solution of PNIPAM ‘microgel’ in water with 4 mmole/l SDS, showed extensive aggregation in the microfluidics device, as shown in TABLE 1.

### Comparative Example 3

### PNIPAM Microgel; Sodium Dioctyl Sulfosuccinate (AOT) Surfactant; 2 wt % BIS, Added Only Before Addition of the Polymerization Initiator (C3)

This PNIPAM microgel was a water swellable cross-linked polymer prepared using AOT as a surfactant. 79 g NIPAM, 1.5 g BIS and 4.5 g AOT were added to a 6 L reactor. 4400 ml milli Q water was added, the mixture warmed to 40° C. and purged with nitrogen for 1 h, while being stirred at 500 rpm. The solution was then heated to 70° C. and equilibrated for 90 min. and 3 g potassium persulfate initiator (dissolved in 50 ml milli Q water which had been purged with nitrogen) was added quickly to the reactor. The mixture was stirred at 400 rpm at 70° C. for 6 h under nitrogen. The reaction mixture rapidly became opalescent, then white. The heating was switched off and the mixture left to cool to room temperature. The reaction yielded a transparent dispersion which was filtered, then dialyzed until the conductivity of the permeate was less than 10 μS/cm.

Cross-linking agent/monomer molar ratio 0.014.
Particle hydrodynamic diameter 137 nm at 20° C.; 59 nm at 50° C.
Volumetric swelling ratio 12.5.

Test of a 4 wt % solution of PNIPAM microgel in water with 4 mmol/l SDS, showed extensive aggregation in the microfluidics device, as shown in TABLE 2.

### Comparative Example 4

### PNIPAM Microgel; SDS Surfactant; 4 wt % BIS Added Only Before Addition of the Polymerization Initiator (C4)

This PNIPAM microgel was a water-swellable cross-linked polymer prepared using SDS as a surfactant. 7.9 g NIPAM, 0.302 g BIS and 0.150 g SDS were added to a 1 L reactor. 450 ml milli Q water was added, the mixture warmed to 40° C. and purged with nitrogen for 45 min., while being stirred at 500 rpm. The solution was then heated to 70° C. and equilibrated for 15 min. and 0.300 g potassium persulfate initiator (dissolved in 10 ml milli Q water which had been purged with nitrogen) was added quickly to the reactor. The mixture was stirred at 400 rpm at 70° C. for 6 h under nitrogen. The reaction mixture rapidly became opalescent, then white. The heating was switched off and the mixture left to cool to room temperature. The reaction yielded a white dispersion which was filtered, then dialyzed until the conductivity of the permeate was less than 10 μS/cm.

Cross-linking agent/monomer molar ratio 0.028.
Particle hydrodynamic diameter 271 nm at 20° C.; 126 nm at 50° C.
Volumetric swelling ratio 9.9.

Test of a 4 wt % solution of PNIPAM microgel in water with 4 mmol/l SDS, showed extensive aggregation in the microfluidics device, as shown in TABLE 1.

### Comparative Example 5

### PNIPAM Microgel; AOT Surfactant; 4 wt % BIS Added Only Before Addition of The Polymerization Initiator (C5)

The PNIPAM microgel was a water-swellable cross-linked polymer prepared using AOT as a surfactant. 8.88 g NIPAM, 0.363 g BIS and 0.505 g AOT were added to a 1 L reactor. 490 ml milli Q water was added, the mixture warmed to 40° C. and purged with nitrogen for 30 min., while being stirred at 500 rpm. The solution was then heated to 70° C. and equilibrated for 30 min. and then 0.337 g potassium persulfate initiator (dissolved in 10 ml milli Q water which had been purged with nitrogen) was added quickly to the reactor. The mixture was stirred at 400 rpm at 70° C. for 6 h under nitrogen. The reaction mixture rapidly became opalescent, then white. The heating was switched off and the mixture left to cool down to room temperature. The reaction yielded a slightly turbid dispersion which was filtered, then dialyzed until the conductivity of the permeate was less than 10 μS/cm.

Crosslinking agent/monomer molar ratio 0.030
Particle hydrodynamic diameter 122 nm at 20° C.; 55 nm at 50° C.
Volumetric swelling ratio 11.1.

Test of a 4 wt % solution of PNIPAM microgel in water with 4 mmol/l SDS, showed no significant aggregation in the microfluidics device, as shown in TABLE 2.

Test of a 4 wt % solution of PNIPAM microgel in water without adding SDS, showed severe aggregation forming even with a flow as low as 2 cm³/h after only 2 min. circulation in the microfluidics device, as shown in TABLE 3.

### Comparative Example 6

### Modified PNIPAM Microgel; SDS Surfactant; 2 wt % BIS Added Before Addition of Polymerization Initiator and Gradually Thereafter (C6)

This modified microgel was prepared using the same composition as in Comparative Example 2, but half of the cross-linking agent was present in the reactor prior to the reaction initiation and the second half was added dropwise just after the reaction had been initiated.

7.9 NIPAM, 0.075 g BIS and 0.150 g SDS were added to a 1 L reactor. 450 ml de-ionized water was added, the mixture warmed to 40° C. and purged with nitrogen for 45 min. while being stirred at 500 rpm. The solution was then heated to 70° C. and 0.300 g potassium persulfate initiator (dissolved in 10 ml deionized water which had been purged with nitrogen) was added quickly to the reactor. 0.075 g BIS (dissolved in 10 ml deionized water which had been purged with nitrogen) was then added dropwise to the reactor at a rate of 0.5 ml/min. The reaction mixture rapidly became opalescent, then white. The mixture was then stirred at 400 rpm at 70° C. for 5 h 40 min under nitrogen. The heating was switched off and the mixture left to cool to room temperature. The reaction yielded a white dispersion which was filtered, then dialyzed until the conductivity of the permeate was less than 10 μS/cm.

Cross-linking agent/monomer molar ratio 0.014.
Particle hydrodynamic diameter 318 nm at 20° C.; 132 nm at 50° C.
Volumetric swelling ratio 14.0.

Test of a 4 wt % solution of this modified PNIPAM microgel in water with 4 mmol/l SDS, showed extensive aggregation in the microfluidics device, as shown in TABLE 1.

### Comparative Example 7

### Modified PNIPAM Microgel; SDS Surfactant; 4 wt % BIS Added Before Addition of Polymerization Initiator and Gradually Thereafter (C7)

This modified microgel was prepared using the same composition as in Comparative Example 4, but half of the cross-linking agent was present in the reactor prior to the reaction initiation and the second half was added dropwise just after the reaction had been initiated. 7.9 NIPAM, 0.151 g BIS and 0.150 g SDS were added to a 1 L reactor. 450 ml deionized water was added, the mixture warmed to 40° C. and purged with nitrogen for 45 min., while being stirred at 500 rpm. The solution was then heated to 70° C. and 0.300 g potassium persulfate initiator (dissolved in 10 ml deionized water which had been purged with nitrogen) was added quickly to the reactor. 0.151 g BIS (dissolved in 10 ml deionized water which had been purged with nitrogen) was added dropwise to the reactor at a rate of 0.5 ml/min. The reaction mixture rapidly became opalescent, then white. The mixture was then stirred at 400 rpm at 70° C. for 5 h 40 min. under nitrogen. The heating was switched off and the mixture left to cool down to room temperature. The reaction yielded a white dispersion which was filtered, then dialyzed until the conductivity of the permeate was less than 10 μS/cm.

Cross-linking agent/monomer molar ratio was 0.028.
Particle hydrodynamic diameter 242 nm at 20° C.; 110 nm at 50° C.
Volumetric swelling ratio 10.6.

Test of a 4 wt % solution of this modified PNIPAM microgel in water with 4 mmol/l SDS, showed extensive aggregation in the microfluidics device, as shown in TABLE 1.

### Comparative Example 8

### Modified PNIPAM Microgel; AOT Surfactant; No Cross-Linking Agent Present Initially but 4 wt % BIS Added 15 min. After Addition of Polymerization Initiator (C8)

This modified microgel was prepared using the same composition as in Comparative Example 5, but no cross-linking agent was present in the reactor prior to the polymerization initiation and the total amount of cross-linking agent was added in a single shot 15 min. after the reaction had been initiated.

8.88 g NIPAM and 0.505 g AOT were added to a 1 L reactor. 470 ml deionized water was added, the mixture warmed to 40° C. and purged with nitrogen for 30 min., while being stirred at 500 rpm. The solution was then heated to 70° C. and equilibrated for 30 min. and 0.337 g potassium persulfate initiator (dissolved in 10 ml deionized water which had been purged with nitrogen) was added quickly to the reactor. The reaction mixture rapidly became opalescent, then white. 15 min. after the addition of the initiator solution, 0.363 g BIS (dissolved in 20 ml deionized water which had been purged with nitrogen) was quickly added to the reactor. The mixture was then stirred at 400 rpm at 70° C. for 5 h 45 min. under nitrogen. The heating was switched off and the mixture left to cool to room temperature. The reaction yielded a slightly turbid dispersion which was filtered, then dialysed until the conductivity of the permeate was less than 10 μS/cm.

Cross-linking agent/monomer molar ratio 0.030
Particle hydrodynamic diameter 168 nm at 20° C.; 60 nm at 50° C.
Volumetric swelling ratio 22.

Test of a 4 wt % solution of this modified PNIPAM microgel in water with 4 mmol/l SDS, showed extensive aggregation in the microfluidics device, as shown on TABLE 2.

### Comparative Example 9

### Modified PNIPAM Microgel; AOT Surfactant; No Cross-Linking Agent Present Initially but 4 wt % BIS, Added 30 min. After Addition of Polymerization Initiator (C9)

This modified microgel was prepared according the method described in Comparative Example 8, but the delay for the cross-linking addition was 30 min. instead of 15 min.

Cross-linking agent/monomer molar ratio 0.030.
Particle hydrodynamic diameter 160 nm at 20° C.; 70 nm at 50° C.
Volumetric swelling ratio 11.9.

Test of a 4 wt % solution of this PNIPAM microgel in water with 4 mmol/l SDS, showed extensive aggregation in the microfluidics device, as shown in TABLE 2.

### Comparative Example 10

### PNIPAM Microgel; AOT Surfactant; 6 wt % Bis, Added Before Addition of Polymerization Initiator (C10)

This PNIPAM microgel is a water-swellable cross-linked polymer prepared using AOT as a surfactant. 7.9 g NIPAM, 0.450 g BIS and 0.450 g AOT were added to a 1 L reactor. 450 ml milli Q water was added, the mixture warmed to 40° C. and purged with nitrogen for 30 min., while being stirred at 500 rpm. The solution was then heated to 70° C. and equilibrated for 30 min. and 0.300 g potassium persulfate initiator (dissolved in 10 ml milli Q water which had been purged with nitrogen) was added quickly to the reactor. The mixture was stirred at 400 rpm at 70° C. for 6 h under nitrogen. The reaction mixture rapidly became opalescent, then white. The heating was switched off and the mixture left to cool to room temperature. The reaction yielded a slightly turbid dispersion which was filtered, then dialyzed until the conductivity of the permeate was less than 10 μS/cm.

Cross-linking agent/monomer molar ratio was 0.042.
Particle hydrodynamic diameter 116 nm at 20° C.; 54 nm at 50° C.
Volumetric swelling ratio 9.6.

Test of a 4 wt % solution of PNIPAM microgel in water with 4 mmol/l SDS, showed no significant aggregation in the microfluidics device, as shown in TABLE 2.

Test of a 4 wt % solution of PNIPAM microgel in water without adding SDS, showed severe aggregation forming even with a flow as low as 2 cm³/h after only 2 min. circulation in the microfluidics device, as shown in TABLE 3.

### Comparative Example 11

### Modified PNIPAM Microgel; AOT Surfactant; 6 wt % Bis Added Before Addition of Polymerization Initiator and Gradually Thereafter (C11)

This modified microgel was prepared using the same composition as in Comparative Example 10, but half of the cross-linking agent was present in the reactor prior to the reaction initiation and the second half was added dropwise just after the reaction had been initiated.

7.9 NIPAM, 0.230 g BIS and 0.450 g AOT were added to a 1 L reactor. 450 ml deionized water was added, the mixture warmed to 40° C. and purged with nitrogen for 45 min., while being stirred at 500 rpm. The solution was then heated to 70° C. and 0.300 g potassium persulfate initiator (dissolved in 10 ml deionized water which had been purged with nitrogen) was added quickly to the reactor. 0.250 g BIS (dissolved in 10 ml deionized water which had been purged with nitrogen) was added dropwise to the reactor at a rate of 0.5 ml/min. The reaction mixture rapidly became opalescent, then white. The mixture was then stirred at 400 rpm at 70° C. for 5 h 40 min. under nitrogen. The heating was switched off and the mixture left to cool to room temperature. The reaction yielded a white dispersion which was filtered, then dialyzed until the conductivity of the permeate was less than 10 μS/cm.

Cross-linking agent/monomer molar ratio 0.044.
Particle hydrodynamic diameter 123 nm at 20° C.; 56 nm at 50° C.
Volumetric swelling ratio 10.6.

Test of a 4 wt % solution of PNIPAM microgel in water with 4 mmol/l SDS, showed no significant aggregation in the microfluidics device, as shown in TABLE 2.

Test of a 4 wt % solution of modified PNIPAM microgel in water without adding SDS, showed medium aggregation forming with a flow even as low as 2 cm³/h after only 2 min. circulation in the microfluidics device, as shown in TABLE 3

### Invention Example 1

### Modified PNIPAM Microgel; SDS Surfactant; 2 wt % Bis Added Before Addition of Polymerization Initiator and 30 min. Thereafter (Inv. 1)

This modified PNIPAM microgel was prepared using the same composition as the PNIPAM microgel described in Comparative Examples 2 and 6, but half of the cross-linking agent was present in the reactor prior to the reaction initiation and the second half was added in a single shot 30 min. after the reaction had been initiated.

7.9 NIPAM, 0.075 g BIS and 0.150 g SDS were added to a 1 L reactor. 450 ml water was added, the mixture warmed to 40° C. and purged with nitrogen for 30 min., while being stirred at 500 rpm. The solution was then heated to 70° C. and 0.300 g potassium persulfate initiator (dissolved in 10 ml deionized water which had been purged with nitrogen) was added quickly to the reactor. The reaction mixture rapidly became opalescent, then white. 30 min. after the addition of the initiator solution, 0.075 g BIS (dissolved in 10 ml deionized water which had been purged with nitrogen) was quickly added to the reactor. The mixture was then stirred at 400 rpm at 70° C. for 5 h 30 min. under nitrogen. The heating was switched off and the mixture left to cool to room temperature. The reaction yielded a white dispersion which was filtered, then dialyzed until the conductivity of the permeate was less than 10 μS/cm.

Cross-linking agent/monomer molar ratio 0.014.
Particle hydrodynamic diameter 320 nm at 20° C.; 128 nm at 50° C.
Volumetric swelling ratio 15.6.

Test of a 4 wt % solution of this PNIPAM microgel in water with 4 mmol/l SDS, did not show aggregation in the microfluidics device, as shown in TABLE 1.

### Invention Example 2

### Modified PNIPAM Microgel; SDS Surfactant; 4 wt % Bis Added Before Addition of Polymerization Initiator and 30 min. Thereafter (Inv. 2)

This modified PNIPAM microgel was prepared using the same composition as the PNIPAM microgel described in Comparative Examples 4 and 7, but half of the cross-linking agent was present in the reactor prior to the reaction initiation and the second half was added in a single shot 30 min. after the reaction had been initiated.

7.9 g NIPAM, 0.151 g BIS and 0.150 g SDS were added to a 1 L reactor. 450 ml water was added, the mixture warmed to 40° C. and purged with nitrogen for 45 min., while being stirred at 500 rpm. The solution was then heated to 70° C. and 0.300 g potassium persulfate initiator (dissolved in 10 ml deionized water which had been purged with nitrogen) was added quickly to the reactor. The reaction mixture rapidly became opalescent, then white. 30 min. after the addition of the initiator solution, 0.151 g BIS (dissolved in 10 ml deionized water which had been purged with nitrogen) was quickly added to the reactor. The mixture was then stirred at 400 rpm at 70° C. for 5 h 30 min. under nitrogen. The heating was switched off and the mixture left to cool to room temperature. The reaction yielded a white dispersion which was filtered, then dialyzed until the conductivity of the permeate was less than 10 μS/cm.

Cross-linking agent/monomer molar ratio 0.028.
Particle hydrodynamic diameter 296 nm at 20° C.; 131 nm at 50° C.
Volumetric swelling ratio 11.5.

Test of a 4 wt % solution of this PNIPAM microgel in water with 4 mmol/l SDS, did not show aggregation in the microfluidics device, as shown in TABLE 1.

### Invention Example 3

### Modified PNIPAM Microgel; AOT Surfactant; 2 wt % Bis Added Before Addition of Polymerization Initiator and 15 min. Thereafter (Inv. 3)

This modified PNIPAM microgel was prepared using the same composition as the PNIPAM microgel described in Comparative Example 3, but half of the cross-linking agent was present in the reactor prior to the reaction initiation and the second half was added in a single shot 15 min. after the reaction had been initiated.

15.8 g NIPAM, 0.160 g BIS and 0.903 g AOT were added to a 1 L reactor. 900 ml milli Q water was added, the mixture warmed to 40° C. and purged with nitrogen for 45 min., while being stirred at 500 rpm. The solution was then heated to 70° C. and equilibrated for 30 min. 0.604 g potassium persulfate initiator (dissolved in 15 ml milli Q water which had been purged with nitrogen) was added quickly to the reactor. The reaction mixture rapidly became opalescent, then white. 15 min. after the addition of the initiator solution, 0.150 g BIS (dissolved in 11 ml milliQ water which had been purged with nitrogen) was quickly added to the reactor. The mixture was then stirred at 400 rpm at 70° C. for 5 h 30 min. under nitrogen. The heating was switched off and the mixture left to cool to room temperature. The reaction yielded a slightly turbid dispersion which was filtered, then dialyzed until the conductivity of the permeate was less than 10 μS/cm.

Cross-linking agent/monomer molar ratio 0.014.
Particle hydrodynamic diameter 155 nm at 20° C.; 58 nm at 50° C.
Volumetric swelling ratio of 19.1.

Test of a 4 wt % solution of this PNIPAM microgel in water with 4 mmol/l SDS, did not show aggregation in the microfluidics device, as shown in TABLE 2.

### Invention Example 4

### Modified PNIPAM Microgel, AOT Surfactant; 2 wt % Bis Added Before Addition of Polymerization Initiator and 30 min. Thereafter (Inv. 4)

This modified microgel was prepared according the method described in Inventive Example 3 but the delay for the cross-linking addition was 30 min. instead of 15 min.

Cross-linking agent/monomer molar ratio 0.014.
Particle hydrodynamic 152 nm at 20° C.; 58 nm at 50° C.,
Volumetric swelling ratio 18.0.

Test of a 4 wt % solution of this PNIPAM microgel in water with 4 mmol/l SDS, did not show aggregation in the microfluidics device, as shown in TABLE 2.

### Inventive Example 5

### Modified PNIPAM Microgel; AOT Surfactant; 4 wt % BIS Added Before Addition of Polymerization Initiator and 30 min. Thereafter (Inv. 5)

This modified PNIPAM microgel was prepared using the same composition as the PNIPAM microgel described in Comparative Example 5, but half of the cross-linking agent was present in the reactor prior to the reaction initiation and the second half was added in a single shot 30 min. after the reaction had been initiated.

7.9 g NIPAM, 0.150 g BIS and 0.453 g AOT were added to a 1 L reactor. 450 ml milli Q water was added, the mixture warmed to 40° C. and purged with nitrogen for 45 min., while being stirred at 500 rpm. The solution was then heated to 70° C. and equilibrated for 30 min. 0.305 g potassium persulfate initiator (dissolved in 10 ml milli Q water which had been purged with nitrogen) was added quickly to the reactor. The reaction mixture rapidly became opalescent, then white. 30 min. after the addition of the initiator solution, 0.152 g BIS (dissolved in 15 ml milliQ water which had been purged with nitrogen) was quickly added to the reactor. The mixture was then stirred at 400 rpm at 70° C. for 5 h 30 min. under nitrogen. The heating was switched off and the mixture left to cool to room temperature. The reaction yielded a slightly turbid dispersion which was filtered, then dialyzed until the conductivity of the permeate was less than 10 μS/cm.

Cross-linking agent/monomer molar ratio 0.028.
Particle hydrodynamic diameter 142 nm at 20° C.; 57 nm at 50° C.
Volumetric swelling ratio 5.5.

Test of a 4 wt % solution of this PNIPAM microgel in water with 4 mmol/l SDS, did not show aggregation in the microfluidics device, as shown in TABLE 2.

Test of a 4 wt % solution of this PNIPAM microgel in water without adding SDS, showed only medium aggregation forming with a flow as low as 2 cm³/h after only 2 min. circulation in the microfluidics device, as shown in TABLE 3.

### Inventive Example 6

### Modified PNIPAM Microgel; AOT Surfactant; 6 wt % BIS, Added Before Addition of Polymerization Initiator and 30 min. Thereafter (Inv. 6)

This modified PNIPAM microgel was prepared using the same method as the method described in Inventive Examples 4 and 0.5, but the total amount of cross-linking agent was increased (as in Comparative Examples 10 and 11).

7.9 g NIPAM, 0.225 g BIS and 0.450 g AOT were added to a 1 L reactor. 450 ml milli Q water was added, the mixture warmed to 40° C. and purged with nitrogen for 45 min., while being stirred at 500 rpm. The solution was then heated to 70° C. and equilibrated for 30 min. 0.300 g potassium persulfate initiator (dissolved in 10 ml milli Q water which had been purged with nitrogen) was added quickly to the reactor. The reaction mixture rapidly became opalescent, then white. 30 min. after the addition of the initiator solution, 0.223 g BIS (dissolved in 10 ml milliQ water which had been purged with nitrogen) was quickly added to the reactor. The mixture was then stirred at 400 rpm at 70° C. for 5 h 30 min. under nitrogen. The heating was switched off and the mixture left to cool to room temperature. The reaction yielded a slightly turbid dispersion which was filtered, then dialyzed until the conductivity of the permeate was less than 10 μS/cm.

Cross-linking agent/monomer molar ratio was 0.041.
Particle hydrodynamic diameter 136 nm at 20° C.; 54 nm at 50° C.
Volumetric swelling ratio 16.0.

Test of a 4 wt % solution of this PNIPAM microgel in water with 4 mmol/l SDS, did not show aggregation in the microfluidics device.

Test of a 4 wt % solution of modified PNIPAM microgel in water without adding SDS, showed only light aggregation forming with a flow as low as 4 cm³/hafter 2 min. circulation in the microfluidics device, as shown in TABLE 3.

TABLE 1

| | | | | Cross- | Cross- | |
|---|---|---|---|---|---|---|
| | | | Particle | Linking | Linking | |
| | | | Diameter | agent | agent | |
| | Example | Particle | (nm) at | prior to | after | |
| Example | type | type | 50° C. | Initiation? | Initiation? | Aggregation? |
| C1 | Comparative | Hard- | 100 | None | None | No |
| | | sphere | | | | |
| | | latex | | | | |
| C2 | Comparative | Microgel | 124 | 2% | None | Yes |
| C6 | Comparative | Microgel | 132 | 1% | 1% added | Yes |
| | | | | | gradually | |
| Inv. 1 | Inventive | Microgel | 128 | 1% | 1% added | No |
| | | | | | after 30 | |
| | | | | | min. | |
| C4 | Comparative | Microgel | 126 | 4% | None | Yes |
| C7 | Comparative | Microgel | 110 | 2% | 2% added | Yes |
| | | | | | gradually | |
| Inv. 2 | Inventive | Microgel | 131 | 2% | 2% added | No |
| | | | | | after 30 | |
| | | | | | min. | |

PNIPAM microgels prepared in the presence of SDS exhibited aggregation under high-shear field if the entirety of cross-linking agent was added only prior to the reaction initiation. A latex dispersion as in Comparative Example 1, with no cross-linking agent, exhibited no aggregation. The aggregation of microgel particles was observed even when the amount of cross-linking agent was doubled (Comparative Examples 2 and 4). However, when part of the cross-linking agent was added in a delayed manner as a single aliquot, leading to a modified PNIPAM microgel, the aggregation under high-shear field was not observed (Inventive Examples 1 and 2). It is to be noted that the microgels of Inventive Examples 1 and 2 are respectively chemically different from those of Comparative Examples 2 and 4, as the volumetric swelling ratio is higher when part of the cross-linking agent is added in a delayed manner as a single aliquot, even when the overall cross-linking agent composition is respectively similar. The manner of adding the second aliquot of cross-linking agent is important as a progressive, dropwise, addition leads to a material which aggregates under high-shear, as demonstrated by Comparative Examples 6 and 7. It is to be noted that the microgels of Inventive Examples 1 and 2 are respectively chemically different from those of Comparative Examples 6 and 7, as the volumetric swelling ratio is lower when part of the cross-linking agent is added in a progressive, dropwise, manner, even when the overall cross-linking agent composition is respectively similar.

TABLE 2

| | | | | Cross- | Cross- | |
|---|---|---|---|---|---|---|
| | | | Particle | Linking | Linking | |
| | | | Diameter | agent | agent | |
| | Example | Particle | (nm) at | prior to | after | |
| Example | type | type | 50° C. | Initiation? | Initiation? | Aggregation? |
| C3 | Comparative | Microgel | 59 | 2% | None | Yes |
| Inv. 3 | Inventive | Microgel | 58 | 1% | 1% added | No |
| | | | | | after 15 | |
| | | | | | min. | |
| Inv. 4 | Inventive | Microgel | 58 | 1% | 1% added | No |
| | | | | | after 30 | |
| | | | | | min. | |
| C5 | Comparative | Microgel | 55 | 4% | None | No |
| Inv. 5 | Inventive | Microgel | 57 | 2% | 2% added | No |
| | | | | | after 30 | |
| | | | | | min. | |
| C8 | Comparative | Microgel | 60 | None | 4% added | Yes |
| | | | | | after 15 | |
| | | | | | min. | |
| C9 | Comparative | Microgel | 70 | None | 4% added | Yes |
| | | | | | after 30 | |
| | | | | | min. | |

PNIPAM microgels prepared in the presence of AOT had smaller size than PNIPAM microgels prepared in the presence of SDS. They also exhibited aggregation under high-shear field when the cross-linking agent was added prior to the reaction initiation. This aggregation was decreased when the amount of cross-linking agent was doubled (Comparative Examples 3 and 5). However, when part of the cross-linking agent was added in a delayed manner in a single aliquot, leading to a modified PNIPAM microgel, the aggregation under high-shear field was not observed (Inventive Examples 3, 4 and 5).

It is to be noted that the microgels of Inventive Examples 4 and 5 are respectively chemically different from those of Comparative Examples 3 and 5, as the volumetric swelling ratio is higher when part of the cross-linking agent is added in a delayed manner in a single aliquot, even if the overall cross-linking agent composition is respectively similar.

Comparative Examples 8 and 9, in which the cross-linking agent was added when the polymerization reaction was substantially complete and no cross-linking agent was added prior to the initiation, exhibited a severe aggregation under high shear-field. This demonstrates that it is not sufficient for a cross-linking agent to be added only when polymerization is substantially complete in order to obtain a modified microgel which does not aggregate under high shear-field, but that portion-wise addition of aliquots of the cross-linking agent is required.

TABLE 3

| | | | | Cross- | Cross- | |
|---|---|---|---|---|---|---|
| | | | Particle | Linking | Linking | |
| | | | Diameter | agent | agent | |
| Example | Example | Particle | (nm) at | prior to | after | |
| ID | type | type | 50° C. | Initiation? | Initiation? | Aggregation? |
| C5 | Comparative | Microgel | 55 | 4% | None | Severe |
| Inv. 5 | Invention | Microgel | 57 | 2% | 2% | Medium |
| C10 | Comparative | Microgel | 54 | 6% | None | Severe |
| C11 | Comparative | Microgel | 56 | 3% | 3% added | Medium |
| | | | | | gradually | |
| Inv. 6 | Inventive | Microgel | 54 | 3% | 3% added | Light |
| | | | | | after 30 | |
| | | | | | min. | |

When PNIPAM microgels were tested under high-shear field without being stabilised by SDS, an improvement was observed in the tendency to aggregate when a cross-linking was added in a delayed manner in a single aliquot.

It is to be noted that the microgels of Inventive Example 6 and those of Comparative Examples 10 and 11 are chemically different, as the volumetric swelling ratio is higher when part of the cross-linking agent is added in a delayed manner in a single aliquot, even when the overall cross-linking agent composition is similar.

1. A method of making a polymeric compound, comprising discrete particles responsive to an external stimulus, that is resistant to aggregation in high-shear fields, which includes the addition of a polymerization initiator to a reaction mixture comprising a monomer corresponding to the polymeric compound, wherein the method comprises the portion-wise addition of aliquots of a cross-linking agent to the reaction mixture, wherein an aliquot of the cross-linking agent is added to the reaction mixture both before the addition of the polymerization initiator and after the polymerization has progressed substantially to completion.

2. (canceled)

3. A method according to claim 1 wherein the polymeric compound is a hydrophilic microgel.

4. A method according to claim 1 wherein the polymer particles are derived from monomers selected from the class consisting of N-alkylacrylamides, N-alkylmethacrylamides, vinylcaprolactam, vinyl methylethers, partially substituted vinylalcohols, ethylene oxide modified benzamide, N-acryloylpyrrolidone, N-acryloylpiperidine, N-vinylisobutyramide, hydroxyalkylacrylates, hydroxyalkylmethacrylate, and copolymers thereof.

5. A method according to claim 1, wherein the polymer particle is poly-N-isopropylacrylamide.

6. A method according to claim 1 wherein the polymer particles are copolymers derived by incorporation of one or more unsubstituted or substituted polymers selected from polyacrylic acid, polylactic acid, polyalkylene oxides, polyacrylamides, polyacrylates, polyethyleneglycol methacrylate, polyvinyl alcohol, polyvinyl acetate, polyvinylpyrrolidone, polyvinyl chloride, polystyrene, polyalkyleneimines, polyurethane, polyester, polyurea, polycarbonate and polyolefins.

7. A method according to claim 1 wherein the polymer particles in their collapsed state have an equivalent spherical diameter of 0.15 μm or less.

8. A method according to claim 1 wherein the cross-linking agent is selected from the class consisting of N,N′-methylene-bisacrylamide, N,N′-ethylenebisacrylamide, dihydroxyethylenebisacrylamide, N,N′-bisacroyloyl-piperazine, ethylene glycol dimethacrylate, polyethylene glycol methacrylate, glycerin triacrylate, divinylbenzene, vinylsulfone and carbodiimides.

9. A method according to claim 8 wherein the total amount of cross-linking agent is from 0.05 to 7 mol % with respect to the monomer corresponding to the polymeric compound.

10. A method according to claim 1 wherein the particles are core/shell particles wherein the polymer surrounds a core and is chemically bonded thereto or physically associated therewith wherein the core is encapsulated within the polymer.

11. A method according to claim 10 wherein the core is polystyrene, latex, silica, titania, a hollows sphere, magnetic or conductive particles or comprises an organic pigment and has an equivalent spherical diameter of less than 2 μm.

12. A method according to claim 1 wherein a surfactant is present and is selected to have no charge or no net charge or to match the ionic charge of the stimulus-responsive particle used.

13. A method according to claim 12 wherein the surfactant is sodium dodecyl sulfate or sodium dioctyl sulfosuccinate.

14. A method according to claim 1 wherein the external stimulus is change in temperature, pH, light, redox potential, electrical, magnetic or a combination thereof.

15. A method according to claim 14 wherein the external stimulus is change in temperature.

16. A polymeric compound, comprising discrete particles responsive to an external stimulus, that is resistant to aggregation in high shear fields, obtainable by a method according to claim 1.

17. A method of reducing or preventing aggregation of an aqueous inkjet printing composition in a high shear field comprising the use of a polymeric compound prepared by a method according to claim 1.

18. A method of reducing or preventing aggregation of an aqueous composition in a high shear field comprising the use of a polymeric compound or a composition thereof wherein the polymeric compound is as prepared by the method according to claim 1.
